(19) United States
(12) Patent Application Publication
(10) Pub. No.: US 2025/0383001 A1
(43) Pub. Date: Dec. 18, 2025

(54) Apparatus and Method For Estimating Wear of a Brake Pad

(71) Applicants: HYUNDAI MOTOR COMPANY, Seoul (KR); KIA CORPORATION, Seoul (KR)

(72) Inventor: Sang Won Son, Hwaseong-si (KR)

(73) Assignees: HYUNDAI MOTOR COMPANY, Seoul (KR); KIA CORPORATION, Seoul (KR)

(21) Appl. No.: 18/942,373

(22) Filed: Nov. 8, 2024

(30) Foreign Application Priority Data
Jun. 18, 2024 (KR) 10-2024-0078783

(51) Int. Cl. F16D 66/02; B60T 13/58; B60T 13/68; B60T 17/22; F16D 66/00

(52) U.S. Cl. CPC F16D 66/026; B60T 13/58; B60T 13/686; B60T 17/22; F16D 66/022; F16D 2066/006

(57) ABSTRACT

An apparatus for estimating wear of a brake pad according to an embodiment of the present disclosure includes a hydraulic circuit, a non-motor on caliper (NMOC), a motor on caliper (MOC), and a control module, wherein the control module includes one or more processors, and a storage medium storing computer-readable instructions that, when executed by one or more processors, cause the one or more processors to control a motor mounted on the motor on caliper (MOC) to move a piston provided in the non-motor on caliper (NMOC), and obtain time required for the brake pad having pressure applied thereto by the piston to contact the disk, and estimate a degree of wear of the brake pad provided in the non-motor on caliper (NMOC) based on the required time.

### CROSS-REFERENCE TO RELATED APPLICATION(S)

This application claims the benefit of priority to Korean Patent Application No. 10-2024-0078783 filed on Jun. 18, 2024, in the Korean Intellectual Property Office, the disclosure of which is incorporated herein by reference in its entirety.

### TECHNICAL FIELD

The present disclosure relates to an apparatus and a method for estimating wear of a brake pad.

### BACKGROUND

A braking device is a device used to stop a vehicle from moving during braking or parking, and serves to generate friction to prevent wheels of a vehicle from rotating. Examples of a braking device include a hydraulic brake configured to generate braking force using hydraulic pressure from a brake pedal and an electronic brake configured to generate braking force using a motor. Here, the electronic brake has been applied to an electronic parking brake (EPB) electronically controlling the operation of a parking brake.

The braking device may generate friction by applying pressure to a rotating disk with a brake pad to brake a vehicle or to keep the vehicle stationary. In this case, a brake pad is a consumable worn out by friction against the disk during a braking process, so that it is necessary to check a degree of wear of the brake pad and replace the brake pad periodically.

### SUMMARY

An aspect of the present disclosure is to provide an apparatus and a method for estimating wear of a brake pad that may estimate a degree of wear of a brake pad provided in a non-motor on caliper (NMOC).

According to an aspect of the present disclosure, provided is an apparatus for estimating wear of a brake pad, including a hydraulic circuit, a non-motor on caliper (NMOC) configured to apply pressure or release pressure of a brake pad on a disk through a piston moving backwards or forwards through oil flowing through the hydraulic circuit, a motor on caliper (MOC) configured to apply pressure or release pressure of the brake pad on the disk through the oil flowing through the hydraulic circuit or the piston moving backwards or forwards by a mounted motor, and a control module, and the control module may include one or more processors, and a storage medium storing computer-readable instructions that, when executed by one or more processors, cause the one or more processors to control a motor mounted on the motor on caliper (MOC) to move a piston provided in the non-motor on caliper (NMOC), and obtain a time required for the brake pad having pressure applied thereto by the piston to contact the disk, and estimate a degree of wear of the brake pad provided in the non-motor on caliper (NMOC) based on the time required.

According to an aspect of the present disclosure, the hydraulic circuit may include an oil reservoir storing oil, a main hydraulic line connected to the oil reservoir, a first sub-hydraulic line branched from the main hydraulic line and providing hydraulic pressure to the non-motor on caliper (NMOC, a second sub-hydraulic line branched from the main hydraulic line and providing the hydraulic pressure to the motor on caliper (MOC), a main valve provided in the main hydraulic line, a first sub-valve provided in the first sub-hydraulic line, and a second sub-valve provided in the second sub-hydraulic line.

According to an aspect of the present disclosure, the one or more processors may be configured to obtain the required time using a level of an operating current of the motor.

According to an aspect of the present disclosure, a liquid required amount for oil flowing into the motor on caliper (MOC) may be less than a liquid required amount of oil flowing into the non-motor on caliper (NMOC).

According to an aspect of the present disclosure, the required time may be the time required until the piston provided in the non-motor on caliper (NMOC) advances from a maximum backwards position to a maximum forward position.

According to an aspect of the present disclosure, the maximum backwards position may be a position of the piston provided in the non-motor on caliper (NMOC) when the piston contacts an end of a cylinder, and the maximum forward position may be a position of the piston provided in the non-motor on caliper (NMOC) when the brake pad pressed by the piston contacts the disk.

According to an aspect of the present disclosure, the one or more processors may be configured to retract the piston provided in the non-motor on caliper (NMOC) to a maximum backwards position by driving the motor, and advance the piston provided in the non-motor on caliper (NMOC), which is retracted by the maximum backwards position, by the maximum forward position.

According to an aspect of the present disclosure, the one or more processors is configured to repeat a cycle of retracting and advancing the piston provided in the motor on caliper (MOC) by driving the motor, and retract the piston provided in the non-motor on caliper (NMOC) by a preset distance unit in each cycle.

According to an aspect of the present disclosure, the one or more processors may be configured to, when the piston provided in the motor on caliper (MOC) moves backwards, open the main valve and the second sub-valve, and close the first sub-valve, and when the piston provided in the motor on caliper (MOC) moves forward, close the main valve, and open the first sub-valve and the second sub-valve.

According to an aspect of the present disclosure, the one or more processors may be configured to, when the piston provided in the motor on caliper (MOC) moves backwards, stop the piston provided in the motor on caliper (MOC) that is moving backwards if a level of an operating current of the motor reaches a preset reference value, and when the piston provided in the motor on caliper (MOC) moves forward, stop the piston provided in the motor on caliper (MOC) that is moving forward if the level of the operating current of the motor reaches the preset reference value.

According to an aspect of the present disclosure, the one or more processors may be configured to measure the time required for backwards movement for each cycle in which the piston provided in the non-motor on caliper (NMOC) moves backwards by a preset distance, but terminate repetition when the time required for backwards movement measured in a previous cycle as compared to the time required for backwards movement measured in a current cycle is equal to or less than a certain ratio.

According to an aspect of the present disclosure, the one or more processors may be configured to repeat a cycle of advancing and retracting the piston provided in the motor on caliper (MOC) by driving the motor, and advance the piston provided in the non-motor on caliper (NMOC) by the preset distance unit in each cycle.

According to an aspect of the present disclosure, the one or more processors may be configured to, when the piston provided in the motor on caliper (MOC) moves forward, close the first sub-valve, and open the main valve and the second sub-valve, and when the piston provided in the motor on caliper (MOC) moves backwards, close the main valve, and open the first sub-valve and the second sub-valve.

According to an aspect of the present disclosure, the one or more processors may be configured to, when a magnitude of an operating current of the motor reaches a preset reference value, stop the piston provided in the motor on caliper (MOC) that is moving backwards, and when the magnitude of the operating current of the motor reaches the preset reference value, stop the piston provided in the motor on caliper (MOC) that is moving forward.

According to an aspect of the present disclosure, the one or more processors may be configured to measure the time required for forward movement for each cycle in which the piston provided in the non-motor on caliper (NMOC) moves forward by a preset distance, but terminate repetition when the time required for forward movement measured in a previous cycle as compared to the time required for forward movement measured in a current cycle is equal to or less than a certain ratio.

According to an aspect of the present disclosure, the required time may be a sum of the time required for forward movement measured for each cycle until the termination of repetition.

According to an aspect of the present disclosure, the one or more processors may be configured to estimate a degree of wear of the brake pad provided in the non-motor on caliper (NMOC) by comparing preset first and second reference times with the required time, and the first reference time may be the time required for the brake pad to contact the disk in a state in which an unworn brake pad is installed, and the second reference time may be the time required for the brake pad to contact the disk in a state in which the brake pad that needs to be replaced is installed.

According to an aspect of the present disclosure, the one or more processors may be configured to estimate a degree of wear of the brake pad when a vehicle is in a parked state.

According to an aspect of the present disclosure, the one or more processors may be configured to inform a user of a degree of wear of the brake pad.

According to an aspect of the present disclosure, provided is a method for estimating wear of a brake pad, comprising controlling a motor mounted on a motor on caliper (MOC) to move a piston provided in a non-motor on caliper (NMOC), and obtaining time required for the brake pad having pressure applied thereto by the piston to contact the disk, and estimating of wear of the brake pad provided in the non-motor on caliper (NMOC) based on the required time.

According to an embodiment of the present disclosure, a motor mounted on a motor on caliper (MOC) may be controlled to move a piston provided in a non-motor on caliper (NMOC) to obtain the time required for a brake pad having pressure applied thereto by the piston to contact a disk, and a degree of wear of the brake pad provided in the non-motor on caliper (NMOC) may be estimated based on the obtained time to estimate the degree of wear of the brake pad provided in the non-motor on caliper (NMOC).

### BRIEF DESCRIPTION OF THE DRAWINGS

The above and other aspects, features, and advantages of the present disclosure will be more clearly understood from the following detailed description, taken in conjunction with the accompanying drawings.

FIG. 1 is a view illustrating an entire system including an apparatus for estimating wear of a brake pad according to an embodiment of the present disclosure.

FIGS. 2A and 2B are views illustrating a process of retracting a piston provided in a non-motor on caliper (NMOC) by a maximum backwards position by driving a motor according to an embodiment of the present disclosure.

FIG. 3 is a view illustrating an operating current of a motor according to an embodiment of the present disclosure.

FIGS. 4A and 4B are views illustrating a process of retracting a piston provided in a non-motor on caliper (NMOC) by a maximum forward position by driving a motor according to an embodiment of the present disclosure.

FIGS. 5A, 5B and 5C are views illustrating a process of estimating a degree of wear of a brake pad provided in a non-motor on caliper (NMOC) according to an embodiment of the present disclosure.

FIGS. 6A and 6B are views illustrating a degree of wear displayed according to an embodiment of the present disclosure.

FIG. 7 is a flowchart illustrating a method for estimating wear of a brake pad according to an embodiment of the present disclosure.

FIG. 8 is a block diagram of a computing device capable of entirely or partially implementing a control module of an apparatus for estimating wear of a brake pad according to an embodiment of the present disclosure.

### DETAILED DESCRIPTION

Hereinafter, a specific embodiment of the present disclosure will be described with reference to the drawings. The following detailed description is provided to help gain a comprehensive understanding of methods, apparatuses, and/or systems described herein. However, this is only an example, and the present disclosure is not limited thereto.

In describing example embodiments of the present disclosure in detail, when it is determined that a detailed description of known technologies associated with the present disclosure may unnecessarily obscure the gist of the present disclosure, a detailed description thereof will be omitted. Furthermore, the terms described below are defined in consideration of functions in the present disclosure, and may vary according to the intention or practice of a user or an operator. Therefore, the definition thereof should be based on the content throughout this specification. The terms used in the description are intended to describe embodiments only, and shall by no means be restrictive. Unless clearly used otherwise, expressions in a singular form include a meaning of a plural form. In the present description, an expression such as “comprising” or “including” is intended to designate a characteristic, a number, a step, an operation, an element, a portion or combinations thereof, and shall not be construed to preclude any presence or possibility of one or more other characteristics, numbers, steps, operations, elements, parts or combinations thereof.

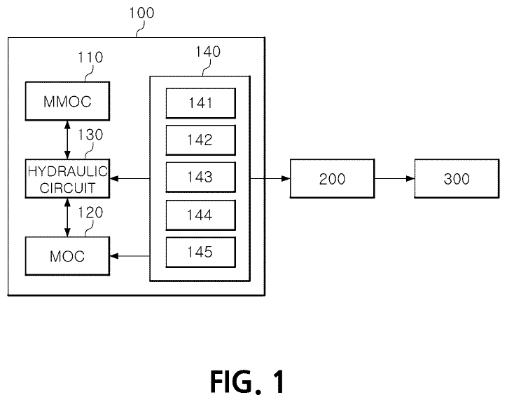

FIG. 1 is a view illustrating an entire system including an apparatus for estimating wear of a brake pad according to an embodiment of the present disclosure. An entire system 10 may include an apparatus 100 for estimating wear of a brake pad, a server 200, and a user terminal 300.

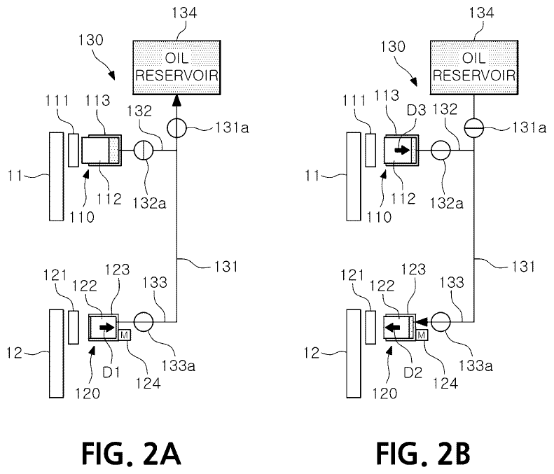

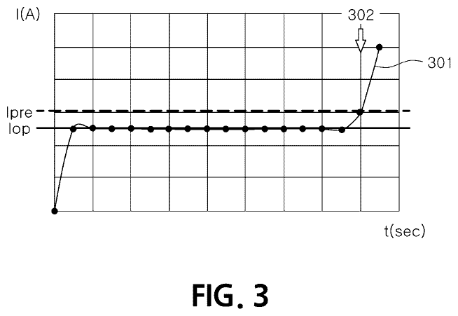

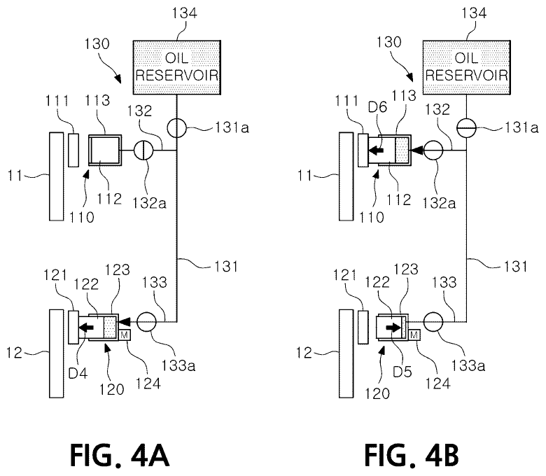

FIGS. 2A and 2B are views illustrating a process of retracting a piston provided in a non-motor on caliper (NMOC) to a maximum backwards position by driving a motor according to an embodiment of the present disclosure, and FIG. 3 is a view illustrating an operating current of a motor according to an embodiment of the present disclosure. Additionally, FIGS. 4A and 4B are diagrams illustrating a process of retracting a piston provided in a non-motor on caliper (NMOC) to a maximum forward position by driving a motor according to an embodiment of the present disclosure.

As illustrated in FIGS. 1 to 5C, the apparatus 100 for estimating wear of a brake pad may include a non-motor on caliper (NMOC) 110, a motor on caliper (MOC) 120, a hydraulic circuit 130, and a control module 140.

Specifically, the non-motor on caliper (NMOC) 110 may apply pressure or release pressure of a brake pad 111 on a disk 11 through a piston 112 moving backwards or forwards by oil flowing through the hydraulic circuit 130. This non-motor on caliper (NMOC) 110 may include the piston 112 configured to pressurize the brake pad 111 and a cylinder 113 configured to guide the piston 112 to move linearly backward and forward, and the piston 112 may move linearly backward and forward due to oil flowing in or out of the cylinder 113.

The motor on caliper (MOC) 120 may apply pressure or release pressure of the brake pad 121 on a disk 12 through oil flowing through the hydraulic circuit 130 or a piston 122 moving backwards or forwards by a mounted motor 124. The motor on caliper (MOC) 120 may include a piston 122 configured to pressurize the brake pad 121, and a cylinder 123 and a motor 124 configured to guide the piston 122 to move linearly backward and forward, and the piston 122 may move linearly backward and forward due to the oil flowing in or out of the cylinder 123 or the motor 124.

The non-motor on caliper (NMOC) 110 may be provided in a front wheel of a vehicle, and the motor on caliper (MOC) 120 may be provided in a rear wheel of the vehicle, but the present disclosure is not necessarily limited thereto.

Additionally, a volume of the cylinder 123 of the motor on caliper (MOC) 120 provided in the rear wheel of the vehicle may be smaller than a volume of the cylinder 113 of the non-motor on caliper (NMOC) 110 provided in the front wheel of the vehicle, so that a liquid required amount for oil flowing into the motor on caliper (MOC) 120 may be smaller than a liquid required amount for oil flowing into the non-motor on caliper (NMOC) 110.

Meanwhile, as illustrated in FIGS. 2A, 2B, 4A and 4B, the hydraulic circuit 130 may include an oil reservoir 134 storing oil, a main hydraulic line 131 connected to the oil reservoir 134, a first sub-hydraulic line 132 branched from the main hydraulic line 131 and providing hydraulic pressure to the non-motor on caliper (NMOC) 110, a second sub-hydraulic line 133 branched from the main hydraulic line 131 and providing hydraulic pressure to the motor on caliper (MOC) 120, a main valve 131a provided in the main hydraulic line 131, a first sub-valve 132a provided in the first sub-hydraulic line 132, and a second sub-valve 133a provided in the second sub-hydraulic line 133.

Meanwhile, the control module 140 may control the motor 124 mounted on the motor on caliper (MOC) 120 to move the piston 112 provided in the non-motor on caliper (NMOC) 110, and may then obtain the time required for the brake pad 111 having pressure applied thereto by the piston 112 to contact the disk 11 and may estimate a degree of wear of the brake pad 111 provided in the non-motor on caliper (NMOC) 110 based on the required time. The control module 140 may obtain the required time using a magnitude of the operating current of the motor 124.

In the present disclosure, the required time may refer to the time required until the piston 112 provided in the non-motor on caliper (NMOC) 110 advances from a maximum backwards position to a maximum forward position. Here, the maximum backwards position may refer to a position of the piston 112 provided in the non-motor on caliper (NMOC) 110 when the piston 112 contacts an end of the cylinder 113, and the maximum forward position may refer to a position of the piston 112 provided in the non-motor on caliper (NMOC) 110 when the brake pad 111 having pressure applied thereto by the piston 112 contacts the disk 11.

The control module 140 described above may include a processor (e.g., a computer, a microprocessor, CPU, ASIC, a logic circuit, or the like) and a memory storing software instructions configured to provide various functions when executed by the processor. Here, the processor and the memory may be implemented as separate semiconductor circuits. Alternatively, the processor and the memory may be implemented as a single integrated semiconductor circuit. One or more processors may be provided.

The control module 140 may include an input unit 141, a controller 142, a storage unit 143, a communication unit 144, and an output unit 145.

The input unit 141 may receive states of the vehicle, more specifically, whether an engine of the vehicle is turned off, a state of a transmission of the vehicle, and vehicle speed, and may transmit the states of the vehicle to the controller 142. Additionally, the input unit 141 may receive an operating current of the motor 124 and transmit the operating current to the controller 142.

The controller 142 may determine whether the vehicle is in a parked state, and estimate a degree of wear of the brake pad when the vehicle is in the parked state, as a result of the determination. The parked state may denote that the engine of the vehicle is turned off (IGN=OFF), the transmission is in a P (Parking) mode, and the vehicle speed is 0 KPH.

Specifically, the controller 142 may retract the piston 112 provided in the non-motor on caliper (NMOC) 110 by the maximum backwards position by driving the motor 124, and advance the piston 112 provided in the non-motor on caliper (NMOC) 110, which is retracted by the maximum backwards position, by the maximum forward position.

FIGS. 2A and 2B are views illustrating a process of retracting a piston provided in a non-motor on caliper (NMOC) by a maximum backwards position by driving a motor according to an embodiment of the present disclosure.

As illustrated in FIGS. 2A and 2B, in order to retract a piston 112 by the maximum backwards position, the controller 142 may repeat a cycle of retracting or advancing a piston 122 provided in the motor on caliper (MOC) 120 by driving the motor 124, and may retract the piston 112 provided in the non-motor on caliper (NMOC) 110 by a preset distance unit in each cycle.

That is, as illustrated in FIG. 2A, the controller 142 may open the main valve 131a and the second sub-valve 133a in the hydraulic circuit 130, and may close the first sub-valve 132a and may then retract the piston 122 provided in the motor on caliper (MOC) 120 (see D1 in FIG. 2A) by driving the motor 124.

In this case, as illustrated in FIG. 3, when the piston 122 provided in the motor on caliper (MOC) 120 moves backwards, the controller 142 may stop the piston 122 provided in the motor on caliper (MOC) 120 that is moving backwards, at the time 302 at which a magnitude of the operating current 301 of the motor 124 reaches a preset reference value Ipre. Here, the preset reference value Ipre may be a tunable value and may be approximately 5% greater than a normal operating current Iop of a motor 125. It should be noted that the above-mentioned specific values are intended to aid understanding of the present disclosure, and the present disclosure is not limited to these specific values.

Then, as illustrated in FIG. 2B, the controller 142 may close the main valve 131a in the hydraulic circuit 130 and may open the first sub-valve 132a and the second sub-valve 133a, and may then advance the piston 122 provided in the motor on caliper (MOC) 120 (see D2 in FIG. 2B) by driving the motor 124. In each cycle, the piston 112 provided in the non-motor on caliper (NMOC) 110 may be retracted by a preset distance unit (see D3 in FIG. 2B).

In this case, as illustrated in FIG. 3, when the piston 122 provided in the motor on caliper (MOC) 120 moves forward, the controller 142 may stop the piston 122 provided in the motor on caliper (MOC) 120 that is moving forwards, at the time 302 at which the magnitude of the operating current 301 of the motor 124 reaches the preset reference value Ipre.

The processes of FIGS. 2A and 2B described above may be performed repeatedly.

Meanwhile, the controller 142 may measure the time required for backwards movement for each cycle in which the piston 112 provided in the non-motor on caliper (NMOC) 110 is retracted by the preset distance, but may terminate repetition when the time required for backwards movement measured in a previous cycle as compared to the time required for backwards movement measured in a current cycle is equal to or less than a certain ratio (e.g. 90%).

For example, when the time required for backwards movement for one cycle is 1 second and the time required for backwards movement for two cycles is 0.2 seconds, the repetition may be terminated.

Meanwhile, FIGS. 4A and 4B are views illustrating a process of advancing a piston provided in a non-motor on caliper (NMOC) by a maximum forward position by driving a motor according to an embodiment of the present disclosure.

As illustrated in FIGS. 4A and 4B, in order to advance the piston 112 by the maximum forward position, the controller 142 may repeat a cycle of advancing and retracting the piston 122 provided in the motor on caliper (MOC) 120 by driving the motor 124, and may advance the piston 112 provided in the non-motor on caliper (NMOC) 110 by the preset distance unit in each cycle.

That is, as illustrated in FIG. 4A, the controller 142 may close the first sub-valve 132a in the hydraulic circuit 130, and may open the main valve 131a and the second sub-valve 133a, and may then advance the piston 122 provided in the motor on caliper (MOC) 120 (see D4 in FIG. 4A) by driving the motor 124.

In this case, as illustrated in FIG. 3, when the piston 122 provided in the motor on caliper (MOC) 120 moves forward, the controller 142 may stop the piston 122 provided in the motor on caliper (MOC) 120 that is moving forward, at the time 302 at which the magnitude of the operating current 301 of the motor 124 reaches the preset reference value Ipre.

Then, as illustrated in FIG. 4B, the controller 142 may close the main valve 131a in the hydraulic circuit 130, and may open the first sub-valve 132a and the second sub-valve 133a, and may then retract the piston 122 provided in the motor on caliper (MOC) 120 (see D5 in FIG. 4B) by driving the motor 124. During the one cycle, the piston 112 provided in the non-motor on caliper (NMOC) 110 may advance by the preset distance unit (see D6 in FIG. 4B).

In this case, as illustrated in FIG. 3, when the piston 122 provided in the motor on caliper (MOC) 120 moves backwards, the controller 142 may stop the piston 122 provided in the motor on caliper (MOC) 120 that is moving forward, at the time 302 at which the magnitude of the operating current 301 of the motor 124 reaches the preset reference value Ipre.

The processes of FIGS. 4A and 4B described above may be performed repeatedly.

Meanwhile, the controller 142 may measure the time required for forward movement for each cycle in which the piston 112 provided in the non-motor on caliper (NMOC) 110 is retracted by the preset distance, but may terminate repetition when the time required for forward movement measured in a previous cycle as compared to the time required for forward movement measured in a current cycle is equal to or less than the certain ratio (e.g. 90%).

For example, when the time required for forward movement for one cycle is 1 second and the time required for forward movement for the second cycle is 0.2 seconds, the repetition may be terminated.

Then, the controller 142 may measure the required time. The time required may be the sum of the time required for forward movement measured for each cycle until the termination of repetition, as illustrated in Equation 1 below.

T3=t1+t2+ . . . +tn [Equation 1]

In Equation 1, T3 refers to required time, and t1 to tn refer to the time required for forward movement required time measured for each cycle.

Then, the controller 142 may estimate a degree of wear of the brake pad 111 provided in the non-motor on caliper (NMOC) 110 by comparing preset first and second reference times with the required time. Here, the first reference time may be the time required for a brake pad to contact the disk in a state in which an unworn brake pad is installed, and the second reference time may be time required for a brake pad to contact the disk in a state in which a brake pad that needs to be replaced is installed.

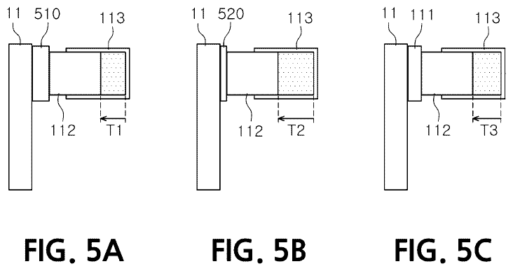

FIGS. 5A, 5B and 5C are views illustrating a process for estimating a degree of wear of a brake pad provided in a non-motor on caliper (NMOC) according to an embodiment of the present disclosure. FIG. 5A refers to a first reference time T1 required for a brake pad 510 to contact a disk 11 in a state in which an unworn brake pad 510 is installed, FIG. 5B refers to a second reference time T2 required for a brake pad 520 to contact the disk 11 in a state in which the brake pad 520 that needs to be replaced is installed, and FIG. 5C refers to a time T3 required for the brake pad 111 to contact the disk 11 in a state in which the brake pad 111 whose degree of wear is to be estimated is installed.

That is, the controller 142 may estimate the degree of wear (wear rate) of the brake pad 111 according to Equation 2 below.

Wear Rate (%)=(T3−T1)/(T2−T1) [Equation 2]

In Equation 2, T1 may be the first reference time, T2 may be the second reference time, and T3 may be the required time.

Referring again to FIG. 1, the storage unit 143 may store a program for implementing the above-described function of the controller 142.

Additionally, the communication unit 144 may transmit the degree of wear of the brake pad 111 to the server 200. The degree of wear of the brake pad 111 transmitted from the communication unit 144 may be transmitted to the user terminal 300 through the server 200.

Then, the user terminal 300 may display the degree of wear of the brake pad 111 received from the server 200 through a display screen 321.

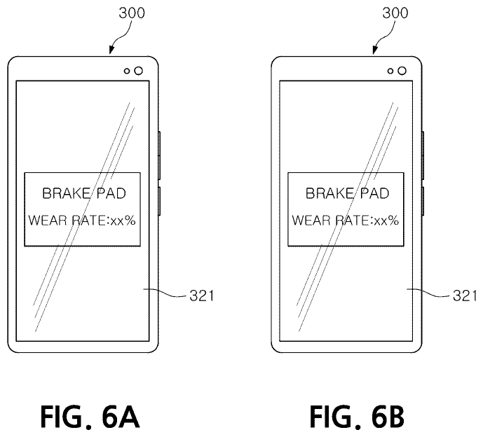

FIGS. 6A and 6B are views illustrating the degree of wear displayed according to an embodiment of the present disclosure.

That is, as illustrated in FIG. 6A, the wear rate of the brake pad 111 may be displayed on the display screen 321, or as illustrated in FIG. 6B, when the wear rate of the brake pad 111 is equal to or greater than a preset rate (e.g., 7%), a text or notification recommending replacement may be generated together.

Meanwhile, the output unit 145 may visually or audibly inform the user of the degree of wear of the brake pad 111.

For example, the output unit 145 may visually inform the user of the degree of wear of the brake pad 111 or the replacement of the brake pad 111, by popping up a message through a cluster including a vehicle display. Alternatively, the output unit 145 may audibly inform the user of the degree of wear of the brake pad 111 or the replacement of the brake pad 111 through sound using an audio device. Visual and auditory methods may be applied separately or simultaneously, and specifically, when replacement of the brake pad 111 is required, the visual and auditory methods may be applied simultaneously to alert the user.

As described above, according to an embodiment of the present disclosure, the motor mounted on the motor on caliper (MOC) may be controlled to move the piston provided in the non-motor on caliper, thus obtaining the time required for the brake pad having pressure applied thereto by the piston to contact the disk, and the degree of wear of the brake pad provided in the non-motor on caliper may be estimated based on the obtained time to estimate the degree of wear of the brake pad provided in the non-motor on caliper.

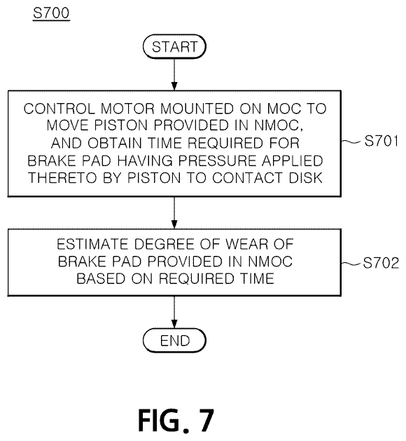

Meanwhile, FIG. 7 is a flowchart illustrating a method for estimating wear of a brake pad according to an embodiment of the present disclosure.

Hereinafter, the method for estimating wear of a brake pad according to an embodiment of the present disclosure will be described with reference to FIGS. 1 to 7. However, for simplification of the disclosure, descriptions overlapping with FIGS. 1 to 6 will be omitted.

Referring to FIGS. 1 to 7, the method S700 for estimating wear of a brake pad according to an embodiment of the present disclosure may begin by an operation of controlling the motor mounted on the motor on caliper (MOC) to move the piston provided in the non-motor on caliper (NMOC), and obtaining the time required for the brake pad having pressure applied thereto by the piston to contact the disk (S701).

Here, the operation of obtaining the required time may further include an operation of opening or closing a main valve provided in a main hydraulic line of a hydraulic circuit that provides oil to the motor on caliper (MOC) and the non-motor on caliper (NMOC), a first sub-valve provided in a first sub-hydraulic line branched from the main hydraulic line and providing hydraulic pressure to the non-motor on caliper (NMOC), and a second sub-valve provided in a second sub-hydraulic line branched from the main hydraulic line and providing the hydraulic pressure to the motor on caliper (MOC).

According to an embodiment of the present disclosure, the liquid required amount for oil flowing into the motor on caliper (MOC) may be less than the liquid required amount for oil flowing into the non-motor on caliper (NMOC).

According to an embodiment of the present disclosure, the required time may be the time required until the piston provided in the non-motor on caliper (NMOC) advances from a maximum backwards position to a maximum forward position.

According to an embodiment of the present disclosure, the maximum backwards position may be a position of the piston provided in the non-motor on caliper (NMOC) when the piston contacts an end of a cylinder, and the maximum forward position may be a position of the piston provided in the non-motor on caliper (NMOC) when a brake pad having pressure applied thereto by the piston contacts the disk.

According to an embodiment of the present disclosure, the operation of obtaining the required time may include an operation of retracting the piston provided in the non-motor on caliper (NMOC) by the maximum backwards position by driving the motor, and an operation of advancing the piston provided in the non-motor on caliper (NMOC), which is retracted by the maximum backwards position, by the maximum forward position.

According to an embodiment of the present disclosure, in the operation of retracting the piston provided in the non-motor on caliper (NMOC) by the maximum backwards position, a cycle of retracting and advancing the piston provided in the motor on caliper (MOC) by driving the motor may be repeated, so that the piston provided in the non-motor on caliper (NMOC) may be retracted by a preset distance unit in each cycle.

According to an embodiment of the present disclosure, the operation of retracting the piston provided in the non-motor on caliper (NMOC) by the maximum backwards position may further include an operation of, when the piston provided in the motor on caliper (MOC) moves backwards, opening the main valve and the second sub-valve and closing the first sub-valve, and, when the piston provided in the motor on caliper (MOC) moves forward, closing the main valve and opening the first sub-valve and the second sub-valve.

According to an embodiment of the present disclosure, in the operation of retracting the piston provided in the non-motor on caliper (NMOC) by the maximum backwards position, when the piston provided in the motor on caliper (MOC) moves backwards, the piston provided in the motor on caliper (MOC) that is moving backwards may be stopped when a magnitude of an operating current of the motor reaches a preset reference value, and when the piston provided in the motor on caliper (MOC) moves forward, the piston provided in the motor on caliper (MOC) that is moving forward may be stopped when the magnitude of the operating current of the motor reaches the preset reference value.

According to an embodiment of the present disclosure, in the operation of retracting the piston provided in the non-motor on caliper (NMOC) by the maximum backwards position, the time required for backwards movement for each cycle in which the piston provided in the non-motor on caliper (NMOC) moves backwards by a preset distance may be measured, but repetition may be terminated when the time required for backwards movement measured in a previous cycle as compared to the time required for backwards movement measured in a current cycle is equal to or less than a certain ratio.

Meanwhile, according to an embodiment of the present disclosure, in the operation of advancing the piston provided in the non-motor on caliper (NMOC) by the maximum forward position, a cycle of advancing and retracting the piston provided in the motor on caliper (MOC) by driving the motor may be repeated, so that the piston provided in the non-motor on caliper (NMOC) may be advanced by the preset distance unit in each cycle.

Meanwhile, the operation of advancing the piston provided in the non-motor on caliper (NMOC) by the maximum forward position may further include an operation of, when the piston provided in the motor on caliper (MOC) moves forward, closing the first sub-valve and opening the main valve and the second sub-valve, and, when the piston provided in the motor on caliper (MOC) moves backwards, closing the main valve and opening the first sub-valve and the second sub-valve.

According to an embodiment of the present disclosure, in the step of advancing the piston provided in the non-motor on caliper (NMOC) by the maximum forward position, when the magnitude of the operating current of the motor reaches the preset reference value, the piston provided in the motor on caliper (MOC) that is moving backwards may be stopped, and when the magnitude of the operating current of the motor reaches the preset reference value, the piston provided in the motor on caliper (MOC) that is moving forward may be stopped.

According to an embodiment of the present disclosure, in the operation of retracting the piston provided in the non-motor on caliper (NMOC) by the maximum forward position, the time required for forward movement for each cycle in which the piston provided in the non-motor on caliper (NMOC) moves forward by the preset distance may be measured, but the repetition may be terminated when the time required for forward movement measured in the previous cycle as compared to the time required for forward movement measured in the current cycle is equal to or less than the certain ratio.

According to an embodiment of the present disclosure, the time required may be the sum of the time for forward movement measured for each cycle until the termination of repetition.

Then, a degree of wear of the brake pad provided in the non-motor on caliper (NMOC) may be estimated based on the required time (S702).

According to an embodiment of the present disclosure, in an operation of estimating the degree of wear of the brake pad provided in the non-motor on caliper (NMOC), the degree of wear of the brake pad provided in the non-motor on caliper (NMOC) may be estimated by comparing preset first and second reference times with the required time, and the first reference time may be the time required for the brake pad to contact the disk in a state in which an unworn brake pad is installed, and the second reference time may be the time required for the brake pad to contact the disk when the brake pad that needs to be replaced is installed.

According to an embodiment of the present disclosure, as described above, the method for estimating wear of the brake pad described above may estimate the degree of wear of the brake pad only when the vehicle is in a parked state.

Additionally, according to an embodiment of the present disclosure, as described above, the degree of wear of the brake pad may be informed to the user or transmitted to the outside.

As described above, according to an embodiment of the present disclosure, the motor mounted on the motor on caliper (MOC) may be controlled to move the piston provided in the non-motor on caliper (NMOC), thus obtaining the time required for the brake pad having pressure applied thereto by the piston to contact the disk, and the degree of wear of the brake pad provided in the non-motor on caliper (NMOC) may be estimated based on the obtained time to estimate the degree of wear of the brake pad provided in the non-motor on caliper (NMOC).

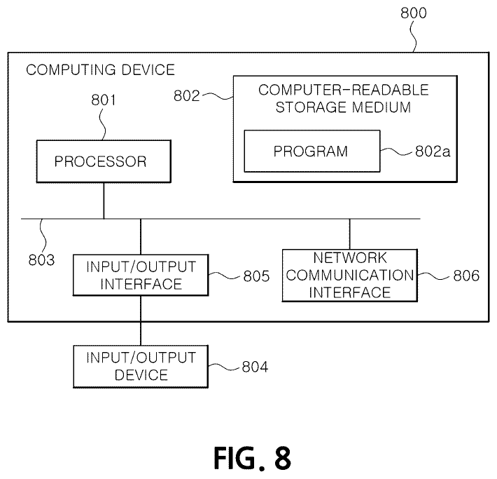

Lastly, FIG. 8 is a block diagram of a computing device 800 that may entirely or partially implement a control module 140 of an apparatus 100 for estimating wear of a brake pad according to an embodiment of the present disclosure.

As illustrated in FIG. 8, the computing device 800 may include at least one processor 801, a computer-readable storage medium 802, and a communication bus 803.

The processor 801 may enable the computing device 800 to operate according to the above-mentioned example embodiments. For example, the processor 801 may execute one or more programs stored in the computer-readable storage medium 802. The one or more programs may include one or more computer executable instructions, and the computer-executable instructions, when executed by the processor 801, may be configured to cause the computing device 800 to perform operations according to example embodiments.

The computer readable storage medium 802 may be configured to store computer-executable instructions or a program code, program data and/or other suitable form of information. A program 802a stored in the computer-readable storage medium 802 includes a set of instructions executable by the processor 801. In an example embodiment, the computer-readable storage medium 802 may be a memory (e.g., a volatile memory, such as a random access memory, a non-volatile memory, or appropriate combinations thereof), one or more magnetic disk storage devices, optical disk storage devices, flash memory devices, another form of storage medium that may be accessed by the computing device 800 and may store desired information, or appropriate combinations thereof.

The communication bus 803 interconnects various other components of the computing device 800, including the processor 801 and the computer-readable storage medium 802.

The computing device 800 may also include one or more input/output interfaces 805 providing an interface for one or more input/output devices 804 and one or more network communication interfaces 806. The input/output interface 805 and the network communication interface 806 are connected to the communication bus 803. The network is a cellular network may be, for example, one of a Global System for Mobile Communications (GSM), Enhanced Data Rates for GSM Evolution (EDGE), a General Packet Radio Service (GPRS), Code Division Multiple Access (CDMA), Time Division-CDMA (TD-CDMA), Universal Mobile Telecommunications System (UMTS), Long Term Evolution (LTE), or another cellular network.

The input/output device 804 may be coupled to other components of the computing device 800 through the input/output interface 805. Exemplary input/output devices 804 may include input devices such as a pointing device (such as a mouse or a trackpad), a keyboard, a touch input device (such as a touchpad or a touch screen), a voice or sound input device, various types of sensor devices and/or imaging devices, and/or output devices such as a display device, a printer, a speaker, and/or a network card. The exemplary input/output devices 804 may be included in the computing device 800 as a component included in the computing device 800, and may be a separate device that is distinct from the computing device 800 and may be connected to the computing device 800.

Meanwhile, embodiments of the present disclosure may include a program for performing the methods described in this specification on a computer, and a computer-readable recording medium including the program. The computer-readable recording medium may include program instructions, local data files, local data structures, and the like, alone or in combination. The medium may be those specifically designed and constructed for the present disclosure, or may be those commonly available in a computer software field. Examples of the computer-readable recording medium include magnetic media such as a hard disk, a floppy disk a and magnetic tape, optical recording media such as CD-ROM and DVD, and hardware devices specially configured to store and execute program instructions, such as ROM, RAM, flash memory, and the like. Examples of the program may include not only a machine language code such as that generated by a compiler, but also a high-level language code that may be executed by a computer using an interpreter or the like.

Although representative example embodiments of the present disclosure have been described in detail above, those skilled in the art will understand that the above-described embodiments may be modified in various ways without departing from the scope of the present disclosure. Therefore, the scope of the present disclosure should not be limited to the described example embodiment and should be determined by the claims described below as well as those equivalent to the claims.

What is claimed is:

1. An apparatus for estimating wear of a brake pad, comprising:
a hydraulic circuit;
a non-motor on caliper (NMOC) configured to apply pressure or release pressure of a brake pad on a disk through a piston moving backwards or forwards through oil flowing through the hydraulic circuit;
a motor on caliper (MOC) configured to apply pressure or release pressure of the brake pad on the disk through the oil flowing through the hydraulic circuit or the piston moving backwards or forwards by a mounted motor; and
a control module, wherein the control module includes
one or more processors, and
a storage medium storing computer-readable instructions that, when executed by one or more processors, cause the one or more processors to
control a motor mounted on the motor on caliper (MOC) to move a piston provided in the non-motor on caliper (NMOC), and obtain a time required for the brake pad having pressure applied thereto by the piston to contact the disk, and
estimate a degree of wear of the brake pad provided in the non-motor on caliper (NMOC) based on the time required.

2. The apparatus for estimating wear of a brake pad according to claim 1, wherein the hydraulic circuit includes
an oil reservoir storing oil,
a main hydraulic line connected to the oil reservoir,
a first sub-hydraulic line branched from the main hydraulic line and providing hydraulic pressure to the non-motor on caliper (NMOC),
a second sub-hydraulic line branched from the main hydraulic line and providing the hydraulic pressure to the motor on caliper (MOC),
a main valve provided in the main hydraulic line,
a first sub-valve provided in the first sub-hydraulic line, and
a second sub-valve provided in the second sub-hydraulic line.

3. The apparatus for estimating wear of a brake pad according to claim 1, wherein the one or more processors is configured to
obtain the required time using a level of an operating current of the motor.

4. The apparatus for estimating wear of a brake pad according to claim 1, wherein a liquid required amount for oil flowing into the motor on caliper (MOC) is less than a liquid required amount of oil flowing into the non-motor on caliper (NMOC).

5. The apparatus for estimating wear of a brake pad according to claim 1, wherein the required time is the time required until the piston provided in the non-motor on caliper (NMOC) advances from a maximum backwards position to a maximum forward position.

6. The apparatus for estimating wear of a brake pad according to claim 5, wherein the maximum backwards position is a position of the piston provided in the non-motor on caliper (NMOC) when the piston contacts an end of a cylinder, and
the maximum forward position is a position of the piston provided in the non-motor on caliper (NMOC) when the brake pad pressed by the piston contacts the disk.

7. The apparatus for estimating wear of a brake pad according to claim 2, wherein the one or more processors is configured to
retract the piston provided in the non-motor on caliper (NMOC) to a maximum backwards position by driving the motor, and
advance the piston provided in the non-motor on caliper (NMOC), which is retracted by the maximum backwards position, by the maximum forward position.

8. The apparatus for estimating wear of a brake pad according to claim 7, wherein the one or more processors is configured to
repeat a cycle of retracting and advancing the piston provided in the motor on caliper (MOC) by driving the motor, and
retract the piston provided in the non-motor on caliper (NMOC) by a preset distance unit in each cycle.

9. The apparatus for estimating wear of a brake pad according to claim 8, wherein the one or more processors is configured to
when the piston provided in the motor on caliper (MOC) moves backwards, open the main valve and the second sub-valve, and close the first sub-valve, and
when the piston provided in the motor on caliper (MOC) moves forward, close the main valve, and open the first sub-valve and the second sub-valve.

10. The apparatus for estimating wear of a brake pad according to claim 8, wherein the one or more processors is configured to,
when the piston provided in the motor on caliper (MOC) moves backwards, stop the piston provided in the motor on caliper (MOC) that is moving backwards if a magnitude of an operating current of the motor reaches a preset reference value, and
when the piston provided in the motor on caliper (MOC) moves forward, stop the piston provided in the motor on caliper (MOC) that is moving forward if the magnitude of the operating current of the motor reaches the preset reference value.

11. The apparatus for estimating wear of a brake pad according to claim 8, wherein the one or more processors is configured to
measure the time required for backwards movement for each cycle in which the piston provided in the non-motor on caliper (NMOC) moves backwards by a preset distance, but terminate repetition when the time required for backwards movement measured in a previous cycle as compared to the time required for backwards movement measured in a current cycle is equal to or less than a certain ratio.

12. The apparatus for estimating wear of a brake pad according to claim 7, wherein the one or more processors is configured to
repeat a cycle of advancing and retracting the piston provided in the motor on caliper (MOC) by driving the motor, and
advance the piston provided in the non-motor on caliper (NMOC) by a preset distance unit in each cycle.

13. The apparatus for estimating wear of a brake pad according to claim 12, wherein the one or more processors is configured to,
when the piston provided in the motor on caliper (MOC) moves forward, close the first sub-valve, and open the main valve and the second sub-valve, and
when the piston provided in the motor on caliper (MOC) moves backwards, close the main valve, and open the first sub-valve and the second sub-valve.

14. The apparatus for estimating wear of a brake pad according to claim 12, wherein the one or more processors is configured to,
when a magnitude of an operating current of the motor reaches a preset reference value, stop the piston provided in the motor on caliper (MOC) that is moving backwards, and
when the magnitude of the operating current of the motor reaches the preset reference value, stop the piston provided in the motor on caliper (MOC) that is moving forward.

15. The apparatus for estimating wear of a brake pad according to claim 12, wherein the one or more processors is configured to
measure the time required for forward movement for each cycle in which the piston provided in the non-motor on caliper (NMOC) moves forward by a preset distance, but terminate repetition when the time required for forward movement measured in a previous cycle as compared to the time required for forward movement measured in a current cycle is equal to or less than a certain ratio.

16. The apparatus for estimating wear of a brake pad according to claim 15, wherein the required time is a sum of the time required for forward movement measured for each cycle until the termination of repetition.

17. The apparatus for estimating wear of a brake pad according to claim 1, wherein the one or more processors is configured to
estimate a degree of wear of the brake pad provided in the non-motor on caliper (NMOC) by comparing preset first and second reference times with the required time,
wherein the first reference time is the time required for the brake pad to contact the disk in a state in which an unworn brake pad is installed, and
the second reference time is the time required for the brake pad to contact the disk in a state in which the brake pad that needs to be replaced is installed.

18. The apparatus for estimating wear of a brake pad according to claim 1, wherein the one or more processors is configured to
estimate a degree of wear of the brake pad when a vehicle is in a parked state.

19. The apparatus for estimating wear of a brake pad according to claim 1, wherein the one or more processors is configured to
inform a user of a degree of wear of the brake pad.

20. A method for estimating wear of a brake pad, the method comprising:
controlling a motor mounted on a motor on caliper (MOC) to move a piston provided in a non-motor on caliper (NMOC), and obtaining time required for the brake pad having pressure applied thereto by the piston to contact a disk, and
estimating of wear of the brake pad provided in the non-motor on caliper (NMOC) based on the required time.
